(19) United States
(12) Patent Application Publication
(10) Pub. No.: US 2026/0072147 A1
(43) Pub. Date: Mar. 12, 2026

(54) SPATIAL PROFILING SYSTEMS AND METHODS

(71) Applicant: Baraja Pty Ltd, New South Wales (AU)

(72) Inventors: Cibby Pulikkaseril, New South Wales (AU); Yannick Keith Lize, New South Wales (AU)

(21) Appl. No.: 19/107,652

(22) PCT Filed: Aug. 29, 2023
(86) PCT No.: PCT/AU2023/050835

§ 371 Date: Feb. 28, 2025

Related U.S. Application Data
(60) Provisional application No. 63/374,570, filed on Sep. 5, 2022.
(60) Provisional application No. 63/490,010, filed on Mar. 14, 2023.

(51) Int. Cl. G01S 7/499; G01S 7/48; G01S 17/08

(52) U.S. Cl. CPC G01S 7/499; G01S 7/4802; G01S 17/08

(57) ABSTRACT

Disclosed is a spatial profiling system for profiling an environment. The spatial profiling system includes a light transmitter for providing light, a beam director for directing the light in one or more directions towards the environment, and a light receiver for receiving return light reflected by a surface or object in the environment. The return light carries information for determining a distance to the surface or object. The light receiver is configured to detect (a) specularity of the return light and (b) polarization state of the return light. The spatial profiling system further includes a processing system configured for determining a material associated with the surface or object based on the detected specularity and the detected polarization state.

### FIELD

The present disclosure generally relates to systems and methods for light-based estimation of a terrestrial or extra-terrestrial environment, for example to LiDAR systems and methods performed by LiDAR systems.

### BACKGROUND

Spatial profiling refers to the two-dimensional (2D) or three-dimensional (3D) mapping of an environment over a 2D or 3D field of view of the environment. Each point or pixel in the field of view is associated with a distance to form a 2D or 3D representation of the environment. Spatial profiles may be useful in identifying objects and/or obstacles in the environment, thereby facilitating automation of tasks.

One technique of spatial profiling involves sending light into an environment in a specific direction and detecting any light reflected back from that direction, for example, by a reflecting surface in the environment. This technique may be referred to as light detection and ranging, or LiDAR. The reflected light carries relevant information for determining the distance to the reflecting surface. The combination of the specific direction and the distance forms a point or pixel in the three-dimensional representation of the environment. The above steps may be repeated for multiple different directions to form other points or pixels of the three-dimensional representation, thereby estimating the spatial profile of the environment within a desired field of view.

### SUMMARY OF THE DISCLOSURE

Spatial profiling systems and components for spatial profiling systems and related methods are described. A spatial estimation formed by the spatial profiling system may be of a terrestrial or an extra-terrestrial environment.

In accordance with an aspect of the disclosure, there is provided a spatial profiling system for profiling an environment, the spatial profiling system including: a light transmitter for providing light, a beam director for directing the light in one or more directions towards the environment, a light receiver for receiving return light reflected by a surface or object in the environment, the return light carrying information for determining a distance to the surface or object, the light receiver being configured to detect (a) specularity of the return light and (b) polarization state of the return light, and a processing system configured for determining a material associated with the surface or object based on the detected specularity and the detected polarization state.

The processing system may be configured to determine the material associated with the surface or object by classifying the material into one of multiple material categories. Classifying the material into one of multiple material categories may include classification includes applying one or more machine learning algorithms.

The light receiver may be further configured to detect specularity based on an image or interference pattern related to speckle. In one embodiment, the image or interference is representative of a spatial sample of the surface or the objected from which light is reflected.

The light receiver may be further configured to detect specularity based on a plurality of despeckled signals. The light receiver may be further configured to recover or provide a measure of amplitude and a measure of phase of one or more of the plurality of despeckled signals.

The processing system may be further configured to determine, based on the detected specularity, any one of speckle contrast, speckle granularity and speckle anisotropy. The processing system may be further configured to determine the material associated with the surface or object, based on any one or more of the determined speckle contrast, speckle granularity and speckle anisotropy.

The light receiver is further configured to detect the polarization state based on a degree of preservation of the polarization state. The degree of preservation of the polarization state may be representative of the degree of polarization of the return light relative to the degree of polarization of the outgoing light or the local oscillator. The processing system may be further configured to determine the material associated with the surface or object, based on the degree of preservation of the polarization state.

As used herein, the terms “first”, “second” and so forth are used to distinguish one entity from another and are not used to indicate or require any particular sequencing, in time, position or otherwise. For example, “a first port and a second port” has the same meaning as “a port and another port”.

As used herein, the terms “optical port” and “port” refer to an area of an optical component through which light passes, and does not necessarily require presence of a physical structure or component. For example one port may be formed by an end of a waveguide or optical fibre, in which case the periphery of the port coincides with an internal surface of the waveguide or optical fibre, whereas another port may be within a larger area of an input slab or an output slab of a wavelength router, in which case the periphery of the port does not coincide with any structure of the waveguide.

As used herein, “light” refers to electromagnetic radiation having optical frequencies, including far-infrared radiation, infrared radiation, visible radiation and ultraviolet radiation.

As used herein a designation of a view or orientation, for instance a top view, a side view, horizontal or vertical is arbitrary for the purposes of illustration and does not suggest any required orientation.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 illustrates an arrangement of a spatial profiling system.

FIG. 2 illustrates an arrangement of a light source, for the spatial profiling system of FIG. 1.

FIG. 3 illustrates an example arrangement of a sensor head, for the spatial profiling system of FIG. 1.

FIG. 4 illustrates sensor head components of the sensor head of FIG. 3.

FIG. 5 illustrates in part a light detector, for the spatial profiling system of FIG. 1.

FIG. 6 illustrates an example of a processing system for classifying surfaces of different materials.

FIG. 7 illustrates an example of an experimental set up for obtaining the experimental observations.

FIGS. 8A and 8B illustrate the performance matrix of a processing system of FIG. 6, trained in accordance with the disclosed training method.

FIG. 9 illustrates the accuracy of a processing system of FIG. 6 under trained different machine learning models.

FIG. 10 illustrates part a light detector, for the spatial profiling system of FIG. 1.

### DETAILED DESCRIPTION OF EMBODIMENTS

A light-based spatial profiling system may be referred to as a light detection and ranging (LiDAR) system. LiDAR involves transmitting light into the environment and detecting the light returned by the environment. By detecting the return light, the system can determine information on the distance of reflecting surfaces within its field of view (FOV), for example the surface of an object or obstacle, the contour of the ground and/or the location of a horizon, a spatial estimation of the environment may be formed.

There are a range of methods for determining distance in or by a LIDAR system. In some embodiments of LiDAR system the distance of a reflecting surface may be determined based on a round-trip-time of the light. In a simple example, the round trip time of a pulse of light is determined, from which the range to a reflecting surface in the direction that the pulse of light was transmitted may be determined. Alternatively or additionally, distance may be determined using frequency-modulated continuous wave (FMCW) techniques. Examples of LiDAR range detection, including examples using FMCW techniques, are discussed in international patent application no. PCT/AU2016/050899 (published as WO 2017/054036 A1), the entire content of which is incorporated herein by reference. In some embodiments, pulses of light that include a time-varying profile are emitted and the time varying profile used for distance determination. In other embodiments, the outgoing light includes a linear frequency chirp, or phase variations for detecting round trip time, instead of detecting the round trip time of a series of modulated pulses.

In three-dimensional mapping, one of the dimensions relates to the range of a point from the origin of the outgoing light, whereas the other two dimensions relate to the two dimensional space (e.g. a space definable by a Cartesian (x, y) or polar (theta, phi) coordinate system) across which the light is directed. The area or angular range over which the light is directed for detection of return light is a field of view of the spatial profiling system. The field of view of the LiDAR system may be fixed or may be a controlled variable.

In some LiDAR systems one or more beams of light are directed into the environment and the one or more optical beams are steered across two dimensions (i.e. a first dimension and a second dimension of a two-dimensional field of view), the combination of knowledge of the steering and the determined range providing information for spatial profiling.

In some other LiDAR systems light is emitted across a wider range, up to across an entire field of view of the LiDAR system. For example, light of different colors may be emitted in different directions within the field of view, to enable determination of both direction and range. The remainder of this description is provided primarily with reference to LiDAR systems that have outgoing light in the form of one or more beams of light, rather than systems that simultaneously emit light across the entire field of view.

In some embodiments the LiDAR system, or a processing system in communication with the LiDAR system, may determine speed or velocity information of an entity, for example a vehicle, where the LiDAR system is located and/or the reflecting surface in the environment. The speed or velocity determination may be based on the detected light returned by the environment, either directly, for example based on Doppler-shifted signals contained in the returned light, or based on a change in distance determination with time. For example in a FMCW system a coherent beat tone of a chirped waveform will reveal the Doppler shift. Additionally or alternatively, the speed information may be obtained or determined from external information that is not derived from the LiDAR system.

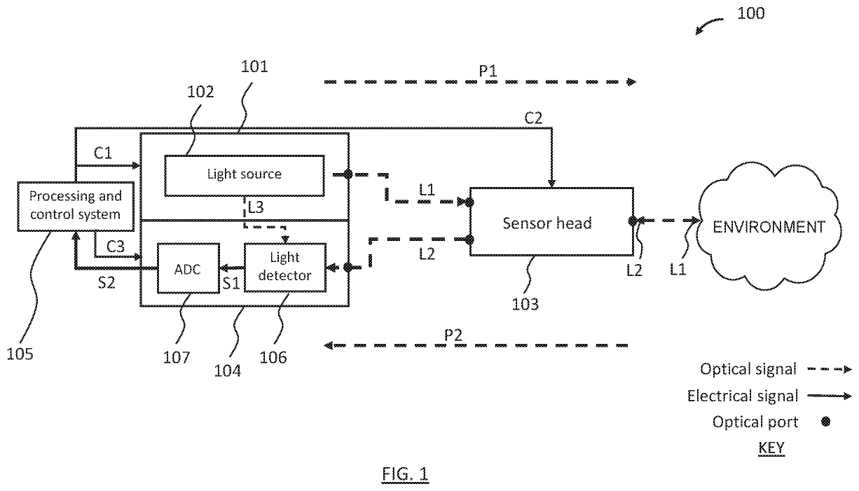

FIG. 1 illustrates an example arrangement of a spatial profiling system 100. As shown in the figure key, in FIG. 1 electrical connections (e.g. analogue or digital data or control signals) are represented by solid lines and optical connections (e.g. guided or free space optical transmission) are represented by dashed lines. Optical input ports and optical output ports of components are represented by solid-filled circles.

The spatial profiling system 100 includes a light transmitter 101, a sensor head 103, a light receiver 104 and a processing and control system 105. The spatial profiling system 100 forms an outgoing light path P1 for outgoing light L1 that is provided to an environment for spatial profiling and an incoming light path P2 for incoming light L2 that is provided to the light receiver 104 for detection. The incoming light L2 includes outgoing light L1 that has been reflected by the environment.

The light transmitter 101 includes a light source 102 for generating the outgoing light L1. The light source 102 may include one light generator or more than one light generator, for example one or more laser diodes. In some embodiments the light source 102 is wavelength-tunable, for selectively providing light at one or more of a range of selectable wavelengths. For example the light source may include one or more wavelength-tunable laser diodes. In some embodiments the light source 102 provides light with a single polarization orientation. In some embodiments the light transmitter 101 includes one or more optical amplifiers for providing gain to the outgoing light L1 and/or one or more optical modulators for imparting a time-variation to at least one property of the outgoing light L1.

Outgoing light L1 from the light transmitter 101 is provided to the sensor head 103. The outgoing light L1 may be provided directly from the light transmitter 101 to the sensor head 103, or indirectly via one or more other optical components in the outgoing light path P1, such as a collimator.

The sensor head 103 directs the outgoing light L1 to the environment. In embodiments in which the outgoing light L1 is in the form of one or more beams of light, the sensor head 103 includes a beam director for controlling the direction of the outgoing light L1.

Where the light source 102 is wavelength-tunable, the sensor head 103 may include one or more wavelength-based beam directors that direct one wavelength of the light source 102 in one direction and another wavelength in another direction. A range of wavelengths may therefore be directed in a range of directions. Depending on the implementation of the beam director, there may be a one-to-one correspondence between the selectable wavelengths and the directions, or one set of a plurality of selectable wavelengths may be directed in a single direction and another set selectable wavelengths directed in another direction.

The sensor head 103 may also or instead include one or more beam directors that include one or more mechanically moveable components to control the direction of the outgoing light, for example one or more scanning mirrors and/or rotating or tilting dispersive or diffractive components. Accordingly, the outgoing light L1 is directed in one direction at one time when the mechanically moveable components are in one position or orientation and directed in another direction at another time when the mechanically moveable components are in another position or orientation, and so forth to provide a range of directions.

The sensor head 103 may include both a wavelength-based beam director and a mechanical beam director. For example, the sensor head 103 may include one or more diffractive and/or dispersive components that direct light based on wavelength, with the directed light provided onto a scanning mirror for mechanical beam direction. In another example, at least one diffractive or dispersive component for wavelength-based beam direction is mounted on a rotating platform, with rotation of the diffractive or dispersive component causing mechanical beam direction. Spatial profiling systems with both wavelength and mechanical beam direction components may be viewed as having a wavelength dimension and a mechanical dimension. The wavelength dimension and a mechanical dimension may be orthogonal or substantially orthogonal.

The sensor head 103 also receives incoming light L2 along the incoming light path P2. In the embodiment shown the sensor head 103 includes a bidirectional port through which both the outgoing light L1 and the incoming light L2 traverse. In other words, the outgoing light path P1 and the incoming light path P2 coincide or overlap at least at the bidirectional port of the sensor head 103. The outgoing light path P1 and the incoming light path P2 may share a common optical axis or have parallel optical axes at the bidirectional port. This sharing of a common optical axis or the presence of parallel optical axes may continue through at least one beam director of the one or more beam directors of the sensor head 103.

In some embodiments the sensor head 103 separates the incoming light L2 from the outgoing light L1. The separation may be achieved by the sensor head 103 directing the incoming light L2 to a different port to the port where the incoming light L1 is received (as represented by the separated ports in FIG. 1) and/or by providing the incoming light L2 from the sensor head 103 so that the light path P2 is not parallel to the light path P2. In other embodiments this separation occurs at another location along the light paths P1, P2, for example proximate or within the light receiver 104.

In still other embodiments the outgoing light path P1 and the incoming light path P2 do not coincide or overlap at or within the sensor head 103. In these embodiments the sensor head may optionally be split into two physical components, one for providing the outgoing light path P1 and one for providing the incoming light path P2.

The incoming light L2 traversing the incoming light path P2 is received by the light receiver 104. The light may be provided directly from the sensor head 103 to the light receiver 104, or indirectly via one or more other optical components in the incoming light path P2, such as an optical filter.

The light receiver 104 includes a light detector 106. The light detector generates a signal S1 based on the incoming light L2. The signal S1 is representative of the information carried by the detected incoming light L2 for determining the distance to the reflecting surface. As shown in FIG. 1, the signal S1 may be an analogue data signal. The light detector 106 may include one or more photodetectors. An example photodetector is an avalanche photodiode (APD). The light receiver 104 may include two photodiodes for balanced detection. Where the processing and control system 105 is a digital system, an analog-to-digital converter 107 converts the analogue data signal to a digital signal S2.

In some embodiments, light from the light source 102 is also provided to the detector 106 to provide a reference light signal or local oscillator light signal L3. The local oscillator light signal L3 is provided to the light receiver 104. The detector circuitry may then be configured to inhibit detection of non-reflected light based on a difference in wavelength or modulation between the outgoing light and the non-reflected light. For example, the light detector 106 may include one or more balanced detectors to coherently detect the reflected light in the incoming light L2 mixed with the reference light. The spatial profiling system 100 may therefore implement coherent (homodyne or heterodyne) detection of the incoming light L2. By way of coherent detection, the light detector 106 is configured to recover, or provide a measure of, both the amplitude (E) and phase (φ) of the incoming light L2, for example, both a function of time (E(t)) and phase (φ(t)). In one example, the light detector 106 includes an in-phase and quadrature (IQ) optical demodulator. The IQ demodulator is configured to combine a first portion of the incoming light L2 with a first (in-phase) portion of the reference light L3, for example via an optical coupler, to provide a first combination. The IQ demodulator is further configured to combine a second portion of the incoming light L2 with a second (quadrature) portion of the reference light L3, for example via another optical coupler, to provide a second combination. The first (in-phase) portion and the second (quadrature) portion of the reference light L3 are phase-separated by 90 degrees of pi/2 radians. The IQ demodulator may include an optical path length, such as an optical delay line, to facilitate the phase separation. Alternatively, the IQ demodulator may include one or more multi-mode interference (MMI) couplers to facilitate the phase separation. The IQ demodulator is configured to generate an electrical in-phase signal (of magnitude I) based on the first combination, and an electrical quadrature signal (of magnitude Q) based on the second combination. The in-phase signal (of magnitude I) and the quadrature signal (of magnitude Q) can be further combined, for example upon digitization by the ADC 107 discussed below, to recover the amplitude (E) and phase (φ) of the incoming light L2. For example, incoming light L2 in a complex-valued representation may be characterised as I+jQ=E exp (jφ). In general, the values of I, Q, E and φ are all a function of time. Other detection methods may be used, such as direct direction. In direct detection there is no need for the local oscillator light signal L3.

The digital signals S2 are received and processed by the processing and control system 105. The processing and control system 105 may, based on the digital signal S2, determine a distance to a reflecting surface (or object) in the environment.

The light transmitter 101 may be controlled by the processing and control system 105 by a control signal over a control line C1. In some embodiments the processing and control system 105 also controls aspects of operation of the other components in the system, for example one or more components of the sensor head 103 over a control line C2 and/or one or more components of the light receiver 104 over a control line C3. Two or more of the control lines C1 to C3, optionally with other control lines, may be combined into a control bus, with the controlled components being individually addressable.

The processing and control system 105 may determine the distance to a reflecting surface of the environment based on its knowledge of the control of components of the spatial profiling system 100. The processing and control system 105 may determine a spatial profile of the environment based on a collection of distance determinations. Alternatively, the processing and control system 105 may include a communications interface with another data processing system, and communicate signals with the other data processing system to enable it to perform the spatial profiling determination based on the distance determinations by the processing and control system 105, or enable it to perform the distance and/or spatial profiling determination.

The processing and control system 105 may include one or more application specific devices configured to perform the operations described herein, such as one or more manufactured or configured programmable logic devices, such as application specific integrated circuits or field programmable gate arrays, or one or more general purpose computing devices, such as microcontrollers or microprocessors, with computer readable memory storing instructions to cause the computing device or devices to perform the operations.

In the instance of an application specific device, the instructions and/or data for controlling operation of the processing unit may be in whole or in part implemented by firmware or hardware elements, including configured logic gates. These elements may be integrated on a common substrate, for example as a system on a chip integrated circuit, or distributed across devices that are on separate substrates.

In the instance of a general purpose computing device, the processing and control system 105 may include, for example, a single computer processing device (e.g. a central processing unit, graphics processing unit, or other computational device), or may include a plurality of computer processing devices. The processing and control system 105 may also include a communications bus in data communication with one or more machine readable storage (memory) devices which store instructions and/or data for controlling aspects of the operation of the processing unit. The memory devices may include system memory (e.g. a BIOS), volatile memory (e.g. random access memory), and non-volatile memory (e.g. one or more hard disk or solid state drives to provide non-transient storage). The operations for spatial profiling are generally controlled by instructions in the non-volatile memory and/or the volatile memory.

In addition, the processing and control system 105 includes one or more interfaces, for example interfaces for the control lines C1 to C3 or a control bus, and an interface to receive the signal S2. An external interface may provide an option to update the firmware and/or software of the processing and control system 105. An external interface may provide an option for a plurality of LiDAR systems to communicate, for example to share information for spatial profiling and/or to share spatial profiles, allowing determinations and actions based on spatial profiling actions of more than one LiDAR system.

In some embodiments the control operations and the data processing operations are performed by separate physical devices. In other embodiments one or more physical devices may perform both control and data processing operations.

In some embodiments the spatial profiling system 100 separates the functional components into two or more physical units. For example the sensor head 103 may be included in one of the physical units and the light transmitter 101, light receiver 104 and the processing and control system 105 may be included in one other physical unit, or one or more of these may be in a further physical unit. In some embodiments the sensor head 103 is remote from one or more of the other components. The remote sensor head 103 may be coupled to the other units via one or more guided optical connections, such as waveguides or optical fibres. A spatial profiling system may include multiple sensor heads 103. Each of the multiple sensor heads 103 may be optically coupled to the light receiver 104 by respective guided optical connections. The multiple sensor heads 103 may be placed at different locations and/or orientated with different fields of view. In an embodiment, light transmitter 101 and light receiver 104 are implemented on the same optical sub-assembly. In another embodiment, light transmitter 101 and light receiver 104 are implemented on different optical sub-assemblies. In either embodiment, the ADC 107 and the processing and control system 106 may be implemented on the same printed circuit board assembly or different printed circuit board assemblies, separate from any optical sub-assembly or sub-assemblies. The printed circuit board assembly or assemblies may include or correspond to a system-on-a-chip (SoC) or a system-on-a-module (SoM).

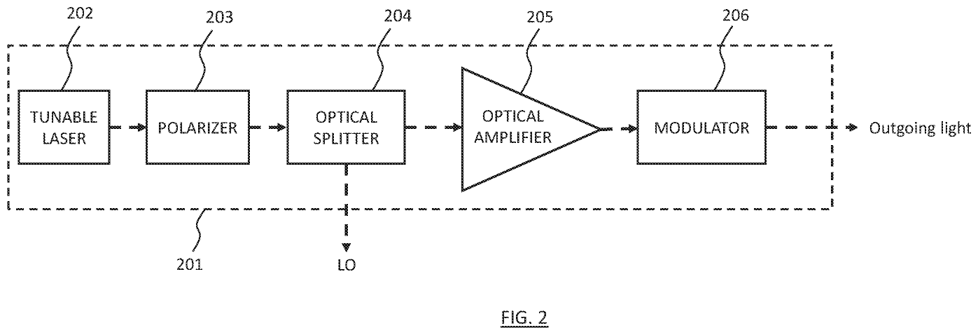

FIG. 2 illustrates an example arrangement of a light transmitter 201, which may for example form the light transmitter 101 of the spatial profiling system 100 described with reference to FIG. 1. In this example, the light transmitter 201 includes a tunable laser 202, for example a wavelength-tunable laser diode, as a source of a beam of light. The tuned wavelength of the tunable laser 202 may be based on one or more electrical currents, for example the injection current into one of more wavelength tuning elements in a laser cavity, applied to the laser diode. In the spatial profiling system 100, the electrical currents are controlled responsive to a control signal over the control line C1.

The light transmitter 201 accordingly is configured to provide a beam of outgoing light at a selected one or more of multiple selectable wavelength channels (each represented by its respective centre wavelength λ₁, λ₂, . . . λ_{N}). In some embodiments the wavelength range of the wavelength-tunable light source is at least 20 nm, or at least 25 nm, or at least 30 nm, or at least 35 nm. The resolution of the wavelength-tunable light source (i.e. smallest wavelength step) may be at most 0.2 nm, preferably at most 0.1 nm, more preferably at most 0.05 nm and even more preferably at most 0.01 nm. In some embodiments the wavelength channels are at about 1550 nm. Other wavelengths may be used, for example about 905 nm. The light transmitter 201 may select one wavelength channel at a time or may simultaneously provide two or more different selected wavelength channels (i.e. channels with different centre wavelengths).

The light from the light source may pass through a polarizer 203, so that the outgoing light to the environment is polarized light. In some embodiments the polarizer 203 is a single polarizer. In other embodiments the polarizer 203 is a cross-polarizer, in which case the polarizer 203 may include two polarizers with perpendicular orientation to one another, or when the source light has a single polarization, provide an orthogonal polarization. In some embodiments the polarizer produces linearly polarized light.

The polarized light from the light source may pass through an optical splitter 204, where a majority portion of the light is continued along an outgoing light path and the remaining portion of the light is provided as a local oscillator signal. For example, the optical splitter 204 may be a 90/10 fiber-optic coupler, providing 90% of the light as outgoing light and 10% of the light as a local oscillator signal for coherent detection.

The light transmitter 101 may also include an optical amplifier 205 to amplify (provide gain to) the outgoing light. In some embodiments the optical amplifier 205 is an Erbium-doped fibre amplifier (EDFA) of one or more stages. In other embodiments one or more stages of a semiconductor optical amplifier (SOA), a booster optical amplifier (BOA), or a solid state amplifier (e.g. a Nd:YAG amplifier) may be used. In the spatial profiling system 100, the gain may be controlled responsive to a control signal over the control line C1. In some embodiments, the optical amplifier 205 is omitted.

In some embodiments, the light transmitter 201 includes a modulator 206 for imparting a time-varying profile on the outgoing light. This modulation may be in addition to any wavelength tuning as herein before described. In other words, the modulation would be of light at the tuned wavelength. It will be appreciated that the tuned wavelength may refer to a center frequency or other measure of a wavelength channel that is generated. The time varying profile may, for example, be one or more of a variation in intensity, frequency, phase or code imparted to the outgoing light. The operation of the modulator 206 (e.g. the modulating waveform), may be controlled by the processing and control system 105 by a control signal over the control line C1.

In one example, the modulator 206 is an external modulator (such as a Mach Zehnder modulator, an electro-optic modulator or an external SOA modulator) to the laser diode. In another example, the modulator 206 is a phase modulator. Although FIG. 2 illustrates an example in which the modulator 206 is located after the optical amplifier 204, it will be appreciated that the modulator may be located either before or after the optical amplifier 205 in the outgoing light path. In one example, the modulator of the light transmitter is a semiconductor optical amplifier (SOA) or a Mach Zehnder modulator integrated on a laser diode of the light source. The electrical current applied to the SOA may be varied over time to vary the amplification of the CW light produced by the laser over time, which in turn provide outgoing light with a time-varying intensity profile. In yet another example, instead of including an integrated or external modulator, the light source includes a laser having a gain medium into which an excitation electrical current is controllably injected for imparting a time-varying intensity profile on the outgoing light. In some embodiments a light source, an optical amplifier and a modulator are provided by a sampled-grating distributed Bragg reflector (SG-DBR) laser.

In another example, the light transmitter 101 may include a broadband light source and one or more tunable spectral filters to provide substantially continuous-wave (CW) light intensity at the selected wavelength(s). In another example, the light transmitter 101 includes multiple laser diodes, each wavelength-tunable over a respective range and whose respective outputs are combined to form a single output. The respective outputs may be combined using a wavelength combiner, such as an optical splitter or an arrayed waveguide grating (AWG).

The light transmitter 101 or the light transmitter 201 may be controllable to provide 10 Gbps modulation, may operate across a 35 nm wavelength range and change from one wavelength channel to another in less than 500 nanoseconds, or 200 nanoseconds or 100 nanoseconds. The wavelength channels may have centre frequencies about 1 GHz or more apart.

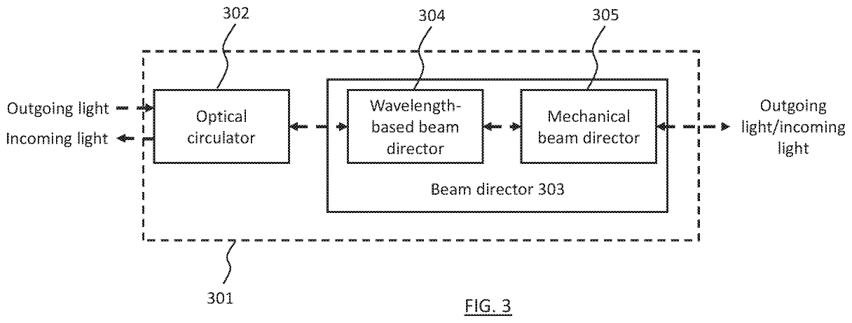

FIG. 3 illustrates an example arrangement of a sensor head 301, which may for example form the sensor head 103 of the spatial profiling system 100 described with reference to FIG. 1. The sensor head 301 includes an optical circulator 302 and a beam director 303, which includes a fast-axis beam director (such as a wavelength-based beam director 304) and a slow-axis beam director (such as a mechanical beam director 305). In general, the fast-axis beam director is configured to direct the beam along a first axis (a “fast axis”) more quickly than slow-axis beam director is configured to direct the beam along a second axis (a “slow axis”), that is orthogonal or substantially orthogonal to the first axis. As illustrated in FIG. 3, the beam director 303 may be downstream of the optical circulator 302 in the outgoing light direction. Alternatively, the optical circulator 302 may be downstream of the beam director 303 in the outgoing light direction. Further, in the beam director 303, the fast-axis beam director may be downstream of the slow-axis beam director in the outgoing light direction. Alternatively, in the beam director 303, the fast-axis beam director may be downstream of the slow-axis beam director in the outgoing light direction.

In some embodiments the optical circulator 302 may be omitted. Separation of the outgoing light path P1 and the incoming light path P2 (see FIG. 1) may be performed by a 2×1 optical coupler. Also, as previously described, in some embodiments only wavelength beam direction or only mechanical beam direction may be performed by the beam director. Additionally, combined wavelength and mechanical beam direction may be performed, through mechanical movement of a component for wavelength-based beam direction.

The blocks of FIGS. 1 to 3 represent functional components of the spatial profiling system 100. Functionality may be provided by distinct or integrated physical components. For example, a light detector may be separate to or integrated with an analogue-to-digital converter (ADC). In another example the optical circulator 302 (or optical coupler) and wavelength-based beam director 304 may be separate physical components or a single integrated component.

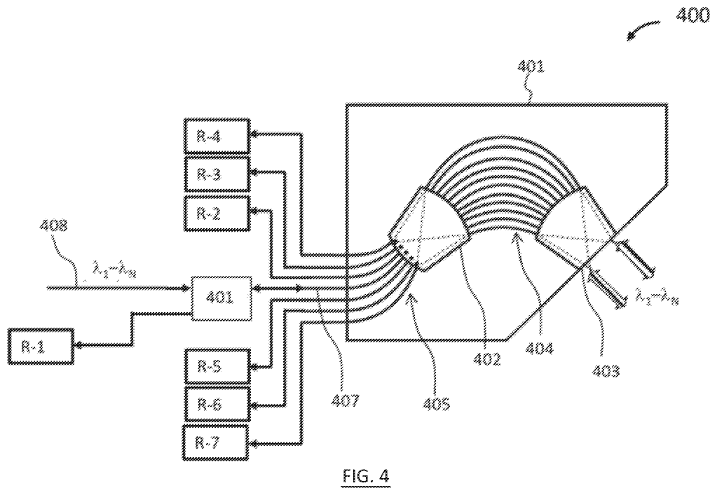

FIG. 4 shows sensor head components 400, for example components of the sensor head 301 of FIG. 3, which may form part of the spatial profiling system of FIG. 1. The components of FIG. 4 are described below in this context. The components include a wavelength router 401, which may form all or part of the wavelength-based beam director 304 of FIG. 3, and an optical circulator 401, which may be the optical circulator 302 of FIG. 3. As previously mentioned, a 2×1 optical coupler may be used instead of an optical circulator.

The wavelength router 400 may include or be an arrayed waveguide grating (AWG) or an Echelle grating or a photonic lantern. The AWG may be fabricated as an integrated circuit chip, for example, in Si, SiO₂ or SiN. Description herein referring to an AWG would be understood by a skilled person in the art to be appliable, without minor modifications, to an Echelle grating or a photonic lantern, all of which may for example distinguish higher order modes from lower order or fundamental modes in the return light.

The wavelength router 400 includes an input slab 402, an output slab 403 and a waveguide array 404. As the wavelength router is a bidirectional component, the terms input and output are used here relative to the outgoing light path P1. For the incoming light path P2, the output slab 403 effectively operates as an input slab of the AWG. The waveguide array 404 includes waveguides of different length, to create interference patterns of an AWG. The wavelength router 400 also includes an array of single mode optical fibres 405, distributed across the input slab 402.

An optical fibre 407 of the array of single mode optical fibres 405 forms part of the outgoing light path P1, and receives outgoing light from the optical circulator 401. The optical circulator 401 receives outgoing light L1 over a light path 408, which may be free-space or guided optical components. The optical fibre 407 is connected to a central location of the input slab 402. The other optical fibres in the array of single mode optical figures 405 are placed across the input slab 402, symmetrically about the optical fibre 407.

The outgoing light L1 is from the light source 102, which is wavelength-tunable, for selectively providing light at a selected one or more of a range of selectable wavelengths λ₁ to λ_{N}. For example, the outgoing light L1 may cycle through each of λ₁ to λ_{N} in order to cover a wavelength dimension. The light source may continuously change wavelength between wavelength channels or may include a step change in wavelength between wavelength channels. Due to the interference in the output slab 403 arising from the waveguide array 404, different wavelengths exit the output slab 403 at different angles. This difference in angle may be used for beam direction. In some embodiments at least one lens or other suitable optical component is provided in the outgoing light path P1, downstream of the output slab 403, for example a collimating lens to collimate the outgoing light and/or a lens to magnify the difference in angle and therefore increase the field of view and/or a polarization wave-plate.

In ideal scenarios without the effects of speckle, propagation of reflected light in the incoming light L2 through the wavelength router 400 would result in the reflected light being imaged to where light originated from, that is back to the location of the optical fibre 407. In practical scenarios, the reflected light in the incoming light L2 is speckled (diffuse), and propagation of reflected light in the return light through the wavelength router 400 results in the reflected light being imaged as a diffused field at the input slab 402. Some of the reflected light is received by the optical fibre 407 and some of the reflected light is received at the other optical fibres in the array of single mode optical fibres 405. Accordingly, across the array of single mode optical fibres 405 an image is formed, the image formed by interfering signals in the input slab 402. The image may therefore be described as an interference pattern. Such an image or interference pattern is representative of a spatial sample of the surface or the objected from which light is reflected. In this way, the target (i.e. the part of the environment reflecting the outgoing light), is spatially sampled, which can be utilised to detect or mitigate speckle effects.

The array of single mode optical fibres 405 therefore each provide a return signal R-1-R-7. Return signals R-1-R-7, which decompose or de-construct speckle effects, are referred herein as “despeckled” signals. In one example, despeckled signals include a set of fundamental mode signal and one or more higher order mode signals. A plurality of these despeckled signals may be provided to the light receiver 104 for detection, such as coherent detection as discussed above. The light detector 106 may be configured to detect the specularity of the return signal, such as detection of the image or interference pattern related to the speckle. In case of coherent detection, the light detector 106 may be further configured to recover or provide a measure of the amplitude and phase of each despeckled signal. In other words, the light detector 106 may be configured to detect specularity based on amplitude and phase of the incoming light in a spatially resolved manner. Whilst the example shows seven fibres, there may be more or less fibres with a corresponding change of more or less receiver channels, ADCs and processing resources. In some embodiments, the light detector 106 is further configured to determine the state of polarization of the return light, such as that of any one or more of the despeckled signals R-1 to R-7. For example, the light detector 106 may include one or more polarizers for each of the despeckled signals R-1 to R-7. Determination of the state of polarization provides an indication of the degree of polarization of the return light, such as how preserved its degree of polarization is upon its reflection from a surface or an object. Further, based on the state of polarization of each of the despeckled signals R-1 to R-7, the degree of polarization of the return light is determined in a spatially resolved manner to facilitate an indication of material characteristics of the surface or object. In particular, the degree of polarization of the return light may be determined relative to the degree of polarization of the outgoing light or the local oscillator.

In some embodiments, each of despeckled signals R-1 to R-7 is converted to an electrical signal by the optical receiver 104, which may be converted to a digital signal, for example by ADC 107. Therefore, the signal S2 of FIG. 1 may be viewed as a composite signal, including a signal component corresponding to each of despeckled signals R-1 to R-7. Signal processing, for example by the processing and control system 105 may then combine the digital signals representing the despeckled signals R-1 to R-7, to reduce speckle effects. In addition, the characteristics of despeckled signals R-1 to R-7, such as one or more of their spatially resolved amplitude, phase and polarization may be used to characterise or categorise the incoming light L2 and therefore provide at least an input to a characterisation or categorisation of the surface generating the reflected light component of the incoming light L2.

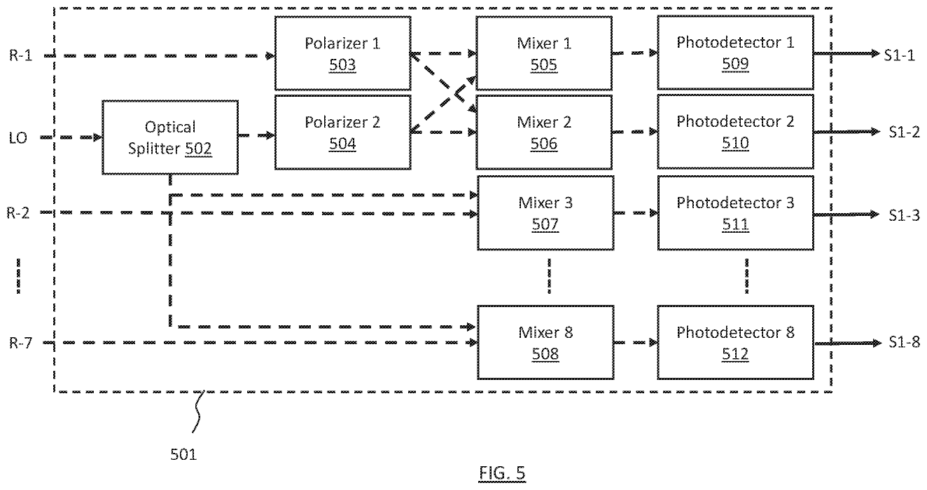

FIG. 5 shows in part a light detector 501, for example the light detector 106 of FIG. 1, for use with the light transmitter 201, including the polarizer 203, and the sensor head components 400. The light detector 501 may be used in the spatial profiling system 100 of FIG. 1. The light detector 501 may include a polarization-diverse light detector configured for coherent detection, such as in-phase and quadrature (IQ) demodulation.

The light detector 501 receives the LO signal, for example from the optical splitter 204. The LO signal may be further divided by an optical splitter 502, to provide N LO signals, where W is the number of return signals for detection. In the example of FIGS. 4 and 5 N is 7. In other embodiments N may be less or more.

The despeckled signal R-1 and the LO signal are polarized by respective first and second polarizers 503, 504. In one example, the first and second polarizers 503, 504 are configured to polarize light in orthogonal polarization orientations, for example corresponding respectively to the polarization orientations aligned with and orthogonal to the polarized light from the polarizer 203. In other words, the first polarizer 503 has a polarization orientation corresponding to one polarization of the polarized light and the second polarizer 505 has a polarization orientation corresponding to the other polarization of the polarized light. In another example, the first and second polarizers 503, 504 are aligned in polarization orientations, for example both corresponding to the polarization orientations aligned with, or orthogonal to, the polarized light from the polarizer 203.

Polarized light from each of the first and second polarizers 503, 504 is provided to both of a first mixer 505 and a second mixer 506. The first and second mixers 505, 506 each produce a mixed signal. This mixed signal is provided to respective first and second photodetectors 509, 510, which produce electrical signals S1-1 and S2-2 respectively. The electrical signals S1-1 and S2-2 carry information for determining the state of polarization of the return light, such as its degree of polarization, including the degree of preservation of polarization state.

The despeckled signal R-2 is provided to a third mixer 507, together with the LO signal. The third mixer produces a mixed signal for detection by a third photodetector 510, which produces electrical signal S1-3. The other despeckled signals R-3 onwards are similarly mixed with the LO signal, up to and including the despeckled signal R-7, which is mixed by an eighth mixer 508 to produce electrical signal S1-8. The signals S1-1 to S1-8 each include beat frequencies arising from the mixing. The signals S1-1 to S1-8 form components of the signal S1 of FIG. 1. These are provided to the ADC 107 and on to the processing and control system 105.

In the embodiment shown in FIG. 5 the despeckled signals R-2 to R-7 are not polarized. In other words, their corresponding electrical signals S1-3 to S1-8 are therefore not polarization resolved. However, in other embodiments some or all of these despeckled signals are also polarized and mixed in a pair of mixers in the same manner as return signal R-1, leading to up to double the signal components in S1 as there are despeckled signals. In these other embodiments, electrical signals S1-3 to S1-8 are polarization resolved.

As mentioned above, the embodiment shown in FIG. 5 is configured for use with polarized outgoing light. When the outgoing light has a single polarization, then the second polarizer 504, the second mixer 506 and the second photodetector 510 may be omitted. In these embodiments the first mixer 1 receives the LO signal from the optical splitter 502.

The despeckled signals R-1 to R-7 and in turn the signals S1 and S2, in particular the component parts of S1, provide information that can be used, for example by the processing and control system 105, to make determinations for spatial profiling. Two different reflecting surfaces may cause different responses of the return signals to the outgoing polarized light. For example, the different responses may include different detected polarization states. Differences in detected polarization states may be based on different ratios in magnitude between signals S1-1 and S1-2 which carry information for determining the polarization state of any one or more of the despeckled signals (e.g. R-1). Similarly two different reflecting surfaces may cause different speckle responses of the return signals to the outgoing light. For example, the different responses may include different detected specularity. Differences in detected specularity may be based on ratios in magnitude between signal S1-1 and any one of signals S1-3 to S1-8, or between signal S1-2 and any one of signals S1-3 to S1-8. These differences are detectable in the components parts of S1.

In some embodiments, the absolute intensity and/or relative intensity of or between polarizations detected is used to distinguish surfaces. For example metal may have a high degree of preservation of polarization, whereas brick, wood and leaves may have a low degree of preservation of polarization and fabric may have a mid-level degree of preservation of polarization. In another example, where coherent detection is used, the phase delay between the two (e.g. orthogonal) polarizations detected by the photodetectors may be used to distinguish surfaces. The use of detected polarization states may apply to just the despeckled signal R-1, or may be expanded to one or more of despeckled signals R-2 to R-7. In another example the relative magnitudes of two or more of despeckled signals R-1 to R-7 may be used to distinguish surfaces.

In some embodiments, the detected specularity is used to distinguish surfaces of different materials. The processing and control system 105 may be configured to determine, based on detected specularity, to classify surfaces into different categories. The detected specularity may include any one of speckle contrast, speckle granularity and speckle anisotropy. Speckle contrast, for example, may be determined based on a standard deviation of intensity normalized by the mean intensity, or severity of speckle. Speckle granularity, for example, may be determined based on the distribution of speckle at different grain sizes. Speckle anisotropy, for example, may be determined based on directional inhomogeneity, or whether grains are longer in a particular direction.

In some embodiments one or more characteristics derived from the detected polarization is used in combination with one or more of the characteristics derived from the detected specularity to distinguish surfaces of different materials. Further, in some embodiments the polarization and/or specularity is used together with still further information, for example information on the location in the field of view, and/or determinations made for areas adjacent the surface in the field of view.

In some embodiments the relevant processing system, for example the processing and control system 105, utilises a look-up process to distinguish surfaces of different materials. For example, the measured polarization state(s) and/or specularity may be matched to a look-up table, with each row of the table having a unique combination of polarisation state(s) and/or specularity and a surface category. The surface category may be specific, for example “wood” or “highly reflective” or may be non-specific, for example “category 1”. It will be appreciated that the surface category may be used for determinations and/or actions, for example by the control system of an autonomous or semi-autonomous vehicle.

In some embodiments, and in particular but not exclusively in embodiments in which there are two or more inputs to the processing to distinguish surfaces of different materials, the relevant processing system, for example the processing and control system 105 determines a material category based on prior machine-learning of relationships between the inputs and categories of surfaces. The machine learning may be supervised machine learning or may be unsupervised machine learning. The machine learning algorithm may include use of an artificial neural network or other machine learning algorithm.

In some embodiments, determination of material category includes classifying a surface into one of multiple material category, based on the detected polarization state and the detected specularity. For examples, the relevant processing system is configured to apply machine-learning algorithms, such as support vector machine (SVM), K-nearest neighbours algorithm (k-NN) or decision trees.

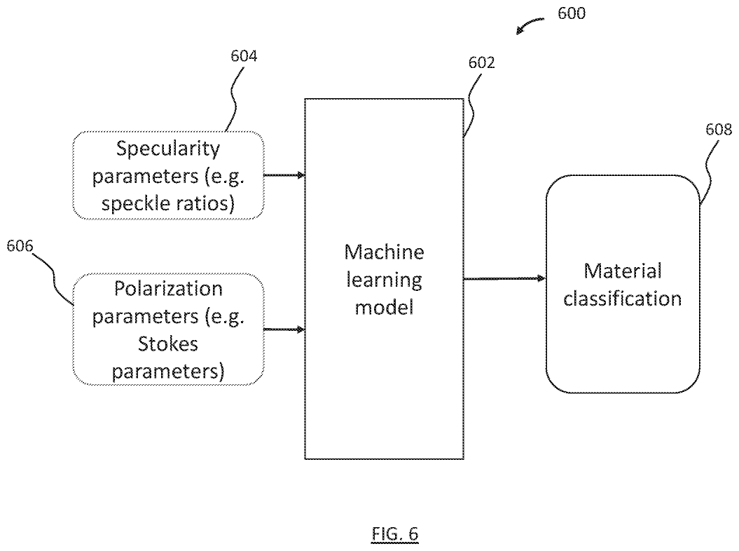

FIG. 6 illustrates an example of a processing system 600 for classifying surfaces of different materials based on a machine-learning framework. The processing system 600 includes a machine-learning model 602, inputs for receiving one or more specularity parameters 604 and one or more polarization parameters 606, and an output for material classification 608. The specularity parameter(s) 604 may include a relative weight or ratio associated with one or more of the despeckled signals R-1 to R-7. The relative weight or ratio may be based on the magnitude (e.g. power, intensity or amplitude) of the one or more of the despeckled signals. Alternatively or additionally, the relative weight or ratio may be based on the phase of the one or more of the despeckled signals. For example, in a spatial profiling system configured to generate three despeckled signals R-1, R-2 and R-3, where R-1 is associated with the fundamental mode and R-2 and R-3 are associated with higher order modes, the received power for R-1 is expected to be substantially higher than that for R-2 and R-3 if the reflecting surface is of a smooth material (e.g. metal). In this case, the specularity parameter(s) 604 may be characterised by a ratio of 90:5:5, denoting that 90% of all received power is solely contributed by despeckled signal R-1 and 10% of all received power is equally contributed by despeckled signals R-2 and R-3 (or 5% contribution each). The ratio 90:5:5 may be alternatively represented by relative weights of 90, 5 and 5 for the respective despeckled signals. Conversely, the received power for R-1 is expected to be comparable to that for R-2 and R-3 if the reflecting surface is of a rough material (e.g. bricks). In this case, the specularity parameter(s) 604 may be characterised by a ratio of 40:30:30, denoting that 40% of all received power is solely contributed by despeckled signal R-1 and 60% of all received power is equally contributed by despeckled signals R-2 and R-3 (or 30% contribution each). The ratio 40:30:30 may be alternatively represented by relative weights of 40, 30 and 30 for the respective despeckled signals R-1, R-2 and R-3. The polarization parameter(s) 606 may include one or more Stokes parameters S0, S1, S2 and S3, together commonly known as the Stokes vector, and each commonly ranging from −1 to +1, although each may be scaled by an arbitrary factor.

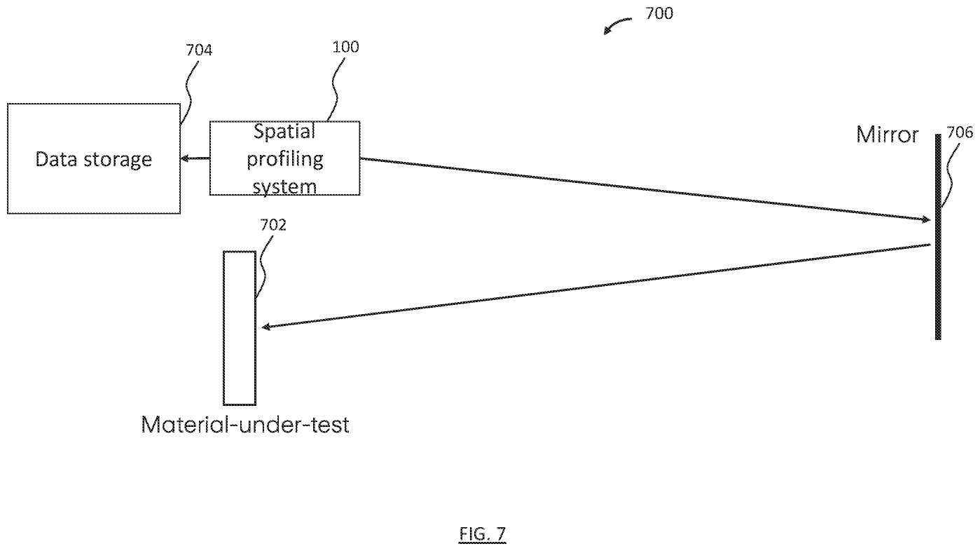

In some embodiments, the processing system 600 is trained by a training method based on a training and validation dataset. The training method may include obtaining a training dataset and a validation dataset by experimental observations. FIG. 7 illustrates an example of an experimental set up 700 for obtaining the experimental observations. The experimental set up 700 includes the spatial profiling system 100, a known material-under-test 702, and a data storage 704. The experimental set up 700 is configured to measure one or more sets of specularity parameter(s) and polarization parameter(s), via the spatial profiling system 100, associated with a number of different materials-under-test for one or more times. The experimental set up 700 is further configured to store each set of measured specularity parameter(s) and polarization parameter(s) in the data storage 704. In one example, the training method includes obtaining a total of 30208 sets of measurement, and separating the sets of measurement into a training dataset of 24224 measurement sets and a validation dataset of 6056 measurement sets, for four different materials under test. The training method further includes fitting the obtained datasets based on one or more machine learning models, for example, in accordance with a standard machine learning framework (e.g. sklearn). Fitting the obtained datasets may include iteratively determining a value of an optimisation function (e.g. based on accuracy of the classification). In each iteration of determining the value of the optimisation function, the machine learning model may be adjusted, for example one or more parameters of the machine learning model are increased or decreased in value, to arrive at a different value of the optimisation function. The iterative determination of the value of the optimisation function may cease responsive to yielding a predetermined maximum or minimum value (e.g. achieving a set accuracy of the classification).

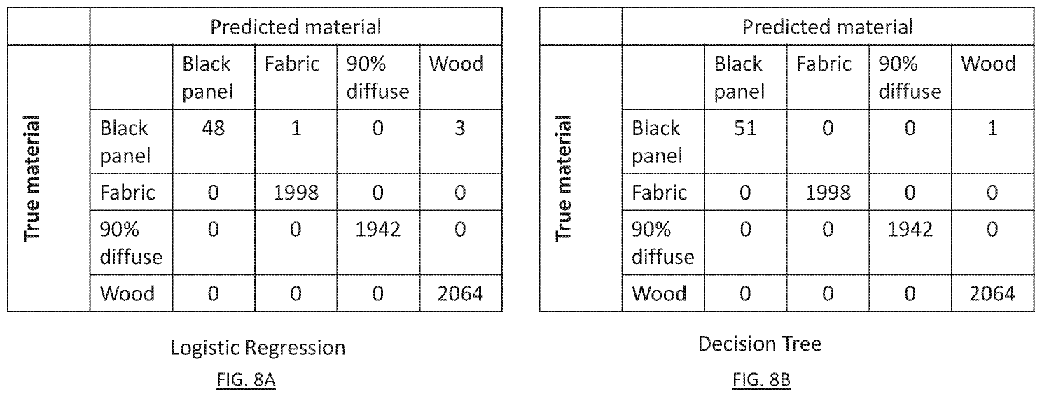

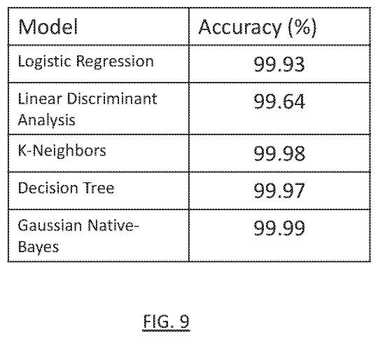

FIGS. 8A and 8B illustrate the performance matrix of the processing system 600, trained in accordance with the disclosed training method under two machine learning models, respectively. The different materials-under-test include a black painted panel material, fabric material, 90% diffuse material, and wood material. The machine learning model includes a linear classifier, such as logistic regression (FIG. 8A). Alternatively, the machine learning model includes a non-linear classifier, such as a decision tree (FIG. 8B). Both machine learning models yield a 99.9% or above accuracy in classifying the 4 different materials under test. FIG. 9 illustrates the accuracy of a trained processing system under different and further machine learning models. It can be seen that each of machine learning models Logistic Regression, Linear Discriminant Analysis, K-Neighbors, Decision Tree and Gaussian Native-Bayes yield a 99% or above accuracy.

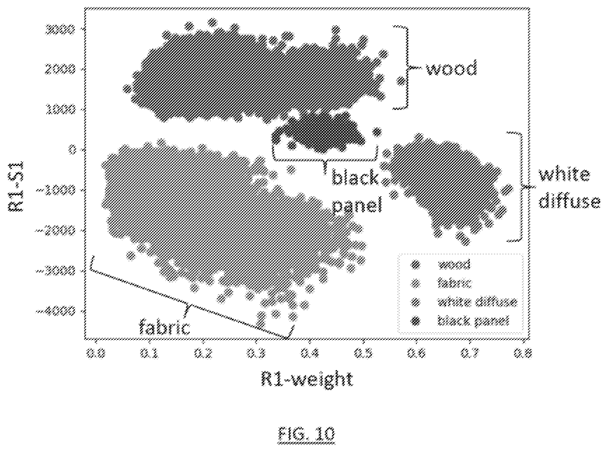

In an embodiment, the processing system 600 is configured to classify materials based on a single specularity parameter 604 and a single polarization parameter 606. The single specularity parameter 604 may be associated with the relative magnitude of one of the despeckled signals. The single polarization parameter 606 may be associated with one of the Stokes parameters. In this example, the spatial profiling system 100 is configured to measure the weight of the received power of despeckled signal R1 relative to all other despeckled signals (R1-weight). The relative weight is a single numerical value from 0 to 1. The spatial profiling system 100 is also configured to measure the Stokes parameter S1 of despeckled signal R1 (R1-S1). The Stokes parameter S1 is a single real value (negative or positive). The values of R1-weight and R1-S1 are measured for 4 different materials (wood material, white diffuse material, black panel material, and fabric material) for multiple times. FIG. 10 illustrates how different materials are associated with such a single specularity parameter and such a single polarization parameter. FIG. 10 illustrates a clear separation in the clusters each representing one of the tested materials based on the single specularity parameter and the single polarization parameter. This clear separation of the clusters corresponds to the high degree of accuracy in machine-learning-based classification based on the single specularity parameter and the single polarization parameter. FIG. 10 also implies that if either a single specularity parameter or a single polarization parameter is used for classifying the materials under test, the separation of the cluster would be lost, and machine-learning-based classification based on either single parameter would not be as accurate.

It will be understood that the invention disclosed and defined in this specification extends to all alternative combinations of two or more of the individual features mentioned or evident from the text or drawings. All of these different combinations constitute various alternative aspects of the invention.

1. A spatial profiling system for profiling an environment, the spatial profiling system including:
a light transmitter for providing light;
a beam director for directing the light in one or more directions towards the environment;
a light receiver for receiving return light reflected by a surface or object in the environment, the return light carrying information for determining a distance to the surface or object, the light receiver being configured to detect (a) specularity of the return light and (b) polarization state of the return light; and
a processing system configured for determining a material associated with the surface or object based on the detected specularity and the detected polarization state.

2. The spatial profiling system of claim 1, wherein the processing system is configured to determine the material associated with the surface or object by classifying the material into one of multiple material categories.

3. The spatial profiling system of claim 2, wherein classifying the material into one of multiple material categories includes classification includes applying one or more machine learning algorithms.

4. The spatial profiling system of claim 1, wherein the light receiver is further configured to detect specularity based on an image or interference pattern related to speckle.

5. The spatial profiling system of claim 4, wherein the image or interference is representative of a spatial sample of the surface or the objected from which light is reflected.

6. The spatial profiling system of claim 1, wherein the light receiver is further configured to detect specularity based on a plurality of despeckled signals.

7. The spatial profiling system of claim 6, wherein the light receiver is further configured to recover or provide a measure of amplitude and/or a measure of phase of one or more of the plurality of despeckled signals.

8. The spatial profiling system of claim 7, wherein the specularity is characterized by one or more specularity parameters, each specularity parameter being associated with the amplitude of one of the one or more of the plurality of despeckled signals.

9. The spatial profiling system of claim 8, wherein the polarization state is characterised by one or more Stokes parameters associated with one of the one or more the plurality of despeckled signals.

10. The spatial profiling system of claim 1, wherein the processing system is further configured to determine, based on the detected specularity, any one of speckle contrast, speckle granularity and speckle anisotropy.

11. The spatial profiling system of claim 10, wherein the processing system is further configured to determine the material associated with the surface or object, based on any one or more of the determined speckle contrast, speckle granularity and speckle anisotropy.

12. The spatial profiling system of claim 1, wherein the light receiver is further configured to detect the polarization state based on a degree of preservation of the polarization state.

13. The spatial profiling system of claim 12, wherein the degree of preservation of the polarization state is representative of the degree of polarization of the return light relative to the degree of polarization of the outgoing light or the local oscillator.

14. The spatial profiling system of claim 12, wherein the processing system is further configured to determine the material associated with the surface or object, based on the degree of preservation of the polarization state.
